(19) United States
(12) Patent Application Publication
(10) Pub. No.: US 2025/0280236 A1
(43) Pub. Date: Sep. 4, 2025

(54) DISPLAY DEVICE AND SOUND OUTPUT METHOD

(71) Applicant: SAMSUNG ELECTRONICS CO., LTD., Suwon-si (KR)

(72) Inventors: Inwoo HWANG, Suwon-si (KR); Kibeom KIM, Suwon-si (KR); Dongwoo KIM, Suwon-si (KR); Sunmin KIM, Suwon-si (KR); Haekwang PARK, Suwon-si (KR); Sangmo SON, Suwon-si (KR)

(73) Assignee: SAMSUNG ELECTRONICS CO., LTD., Suwon-si (KR)

(21) Appl. No.: 19/210,783

(22) Filed: May 16, 2025

Related U.S. Application Data
(63) Continuation of application No. PCT/KR2023/017458, filed on Nov. 3, 2023.

(30) Foreign Application Priority Data
Dec. 23, 2022 (KR) 10-2022-0183592

(51) Int. Cl. H04R 3/04

(52) U.S. Cl. CPC H04R 3/04; H04R 2430/01; H04R 2430/03; H04R 2499/15

(57) ABSTRACT

A display device includes: a content receiver configured to receive content data from a content source; and a processor operatively connected to the content receiver, wherein the processor is configured to: obtain audio data from the content data and convert the audio data to an audio signal, adjust at least one of first output power of a voice signal included in the audio signal or second output power of a non-voice signal included in the audio signal, based on whether the audio signal is music or a volume.

### CROSS-REFERENCE TO RELATED APPLICATIONS

This application is a by-pass continuation application of International Application No. PCT/KR2023/017458, filed on Nov. 3, 2023, which is based on and claims priority to Korean Patent Application No. 10-2022-0183592, filed on Dec. 23, 2022, in the Korean Intellectual Property Office, the disclosures of which are incorporated by reference herein their entireties.

### BACKGROUND

### 1. Field

The disclosure relates to a display device and sound output method.

### 2. Description of Related Art

In general, display devices are an output device for visually presenting image information received or stored for the user, and are used in various areas such as homes or businesses. For example, there are many different display devices such as monitor devices connected to personal computers (PCs) or server computers, portable computer systems, Global Positioning System (GPS) terminals, general television sets, Internet protocol televisions (IPTVs), portable terminals, e.g., smart phones, tablet PCs, personal digital assistants (PDAs), and cellular phones, any other display device for reproducing images like advertisements or films, or other various kinds of audio/video systems.

The display device may receive content from various content sources, such as a broadcasting station, an Internet server, a video playback device, a game device or a portable terminal. Furthermore, the display device may reconstruct images and sound from the content and output the reconstructed image and sound.

Recently, researches on image processing and audio processing of the display device have been done actively. Technologies for separating the audio signal into a voice signal and other signals, and thus, enhancing voice delivery are being developed.

### SUMMARY

Provided are a display device and sound output method that are capable of enhancing delivery of a voice included in an audio signal based on a probability that the audio signal is music and the volume of the display device.

According to an aspect of the disclosure, a display device includes: a content receiver configured to receive content data from a content source; and a processor operatively connected to the content receiver, wherein the processor is configured to: obtain audio data from the content data and convert the audio data to an audio signal, adjust at least one of first output power of a voice signal included in the audio signal or second output power of a non-voice signal included in the audio signal, based on whether the audio signal is music or a volume.

According to an aspect of the disclosure, a sound output method includes: receiving content data from a content source; obtaining audio data from the content data; converting the audio data to an audio signal; and adjusting at least one of first output power of a voice signal included in the audio signal or second output power of a non-voice signal included in the audio signal, based on whether the audio signal is music or a volume.

According to one or more embodiments, a display device and sound output method may enhance delivery of a voice included in an audio signal based on a probability that the audio signal is music and a volume of the display device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an exterior of a display, according to an embodiment;

FIG. 2 is a block diagram of a display, according to an embodiment;

FIG. 3 is a block diagram of a controller included in a display device, according to an embodiment;

FIG. 4 is a flowchart for describing a sound output method of a display device, according to an embodiment;

FIG. 5 is a diagram for describing adjustment of output power of an audio signal based on a probability that the audio signal is music, according to an embodiment; and

FIG. 6 is a diagram for describing adjustment of output power of an audio signal based on a volume of a display device, according to an embodiment.

### DETAILED DESCRIPTION

Embodiments and features as described and illustrated in the disclosure are merely examples, and there may be various modifications replacing the embodiments and drawings at the time of filing this application.

The term “connect” or its derivatives refer both to direct and indirect connection, and the indirect connection includes a connection over a wireless communication network.

The terminology used herein is for the purpose of describing particular embodiments only and is not intended to limit the disclosure. The singular forms “a,” “an,” and “the” include plural references unless the context clearly dictates otherwise. The terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. For example, a first element could be termed a second element and vice versa, without departing from the scope of the disclosure.

Furthermore, the terms such as “˜ part”, “˜ block”, “˜ member”, “˜ module”, etc., may refer to a unit of handling at least one function or operation. For example, the terms may refer to at least one process handled by hardware such as field-programmable gate array (FPGA)/application specific integrated circuit (ASIC), etc., software stored in a memory, or at least one processor. The terms such as “˜ part”, “˜ block”, “˜ member”, “˜ module” may be implemented by a program that is stored in a storage medium which may be addressed, and is executed by a processor. For example, the terms such as “˜ part”, “˜ block”, “˜ member”, “˜ module” may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters.

Reference numerals used for method steps are just used to identify the respective steps, but not to limit an order of the steps. Thus, unless the context clearly dictates otherwise, the written order may also be practiced otherwise.

Reference will now be made in detail to embodiments of the disclosure, which are illustrated in the accompanying drawings.

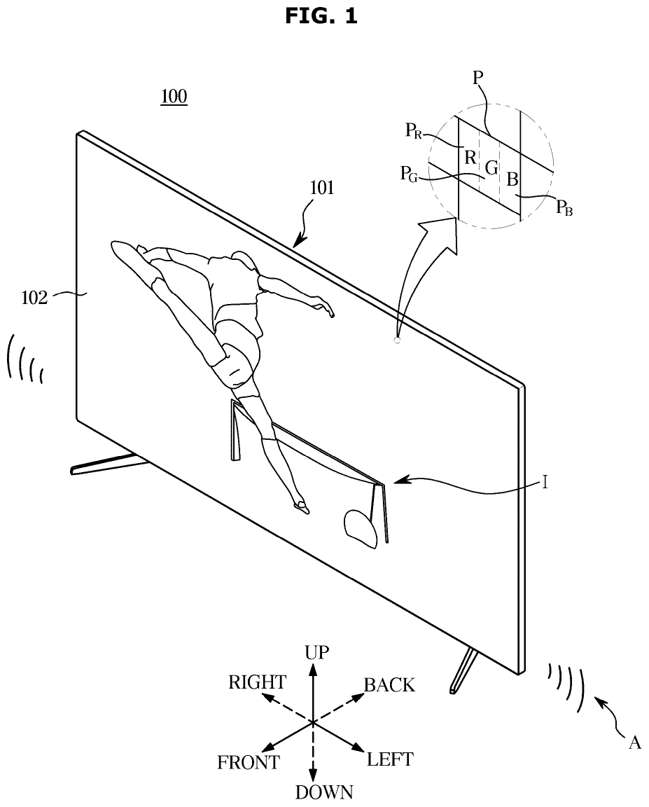

FIG. 1 illustrates an exterior of a display, according to an embodiment.

A display device 100 is able to process image signals received from the outside and visually present the processed image. For example, the display device 100 may be implemented in various product forms such as a television (TV), a monitor, a portable multimedia device, a portable communication device, a portable operation device, etc., and the display device 100 is not limited to a particular form as long as it is capable of visually reproducing image signals and audibly reproducing audio signals.

The display device 100 may be a large format display (LFD) installed outdoors such as on a rooftop of a building or at a bus stop. The display device 100 is not, however, exclusively installed outdoors, but may be installed at any place, even indoors with a lot of foot traffic, e.g., at subway stations, shopping malls, theaters, offices, stores, etc.

The display device 100 may receive contents including video and sound from various content sources and output video and sound included in the content. For example, the display device 100 may receive television (TV) broadcast content through a broadcast receiving antenna or a cable, receive multimedia content from a content reproducing device through a multimedia cable, or receive streaming content from a content streaming server over a communication network.

As shown in FIG. 1, the display device 100 may include a main body 101 that is configured to accommodate a plurality of components for displaying images, and a display panel 102 arranged on one side of the main body 101 for displaying image (“I” in FIG. 1).

The main body 101 forms the exterior of the display device 100, and components for the display device 100 to output the image “I” and sound “A” may be arranged in the main body 101. The main body 101 shown in FIG. 1 is shaped like a flat plate, but the shape of the main body 101 is not limited thereto, and the main body 101 may have a curved form with left and right ends relatively coming forward and the other parts curved backward.

The display panel 102 may be formed on the front of the main body 101 for displaying visual information, i.e., the image “I”. For example, the display panel 102 may display still or moving images in two dimension (2D) or three dimension (3D).

A plurality of pixels P are formed on the display panel 102, and the image “I” displayed on the display panel 102 may be formed by a combination of rays emitted by the plurality of pixels P. For example, the rays emitted by the plurality of pixels P may be combined like a mosaic and formed into one image “I” on the display panel 102.

The plurality of pixels P may each emit light in various colors and brightness.

To emit light with different brightness, each of the plurality of pixels P may include an element that may emit light directly (e.g., an organic light emitting diode (OLED)) or an element capable of transmitting or blocking light illuminated by e.g., a backlight unit (e.g., a liquid crystal panel).

Each of the pixels P may include subpixels PR, PG, and PB to emit different colors of light. The subpixels PR, PG, and PB may include a red subpixel PR to emit red light, a green subpixel PG to emit green light, and blue subpixel PB to emit blue light. For example, the red subpixel PR may emit red light having a wavelength of about 620 nanometers (nm, a billionth of a meter) to about 750 nm; the green subpixel PG may emit green light having a wavelength of about 495 nm to about 570 nm; the blue subpixel PB may emit blue light having a wavelength of about 450 nm to about 495 nm.

By combinations of the red light of the red subpixel PR, the green light of the green subpixel PG, and the blue light of the blue subpixel PB, each of the pixels P may emit various brightness and colors of light.

Furthermore, the main body 101 may be equipped with a speaker on the rear side or a lateral side to output the sound “A”. The speaker may output the sound “A” included in the content received by the display device 100 from a content source.

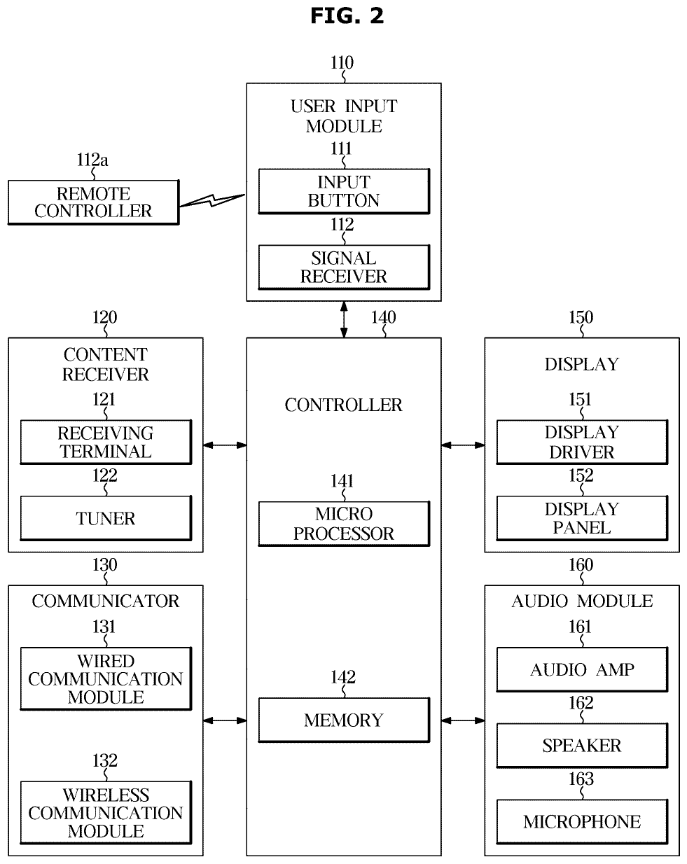

FIG. 2 is a block diagram of a display, according to an embodiment.

The display device 100 includes a user input module 110 for receiving a user input from the user, a content receiver (or content receiving part) 120 for receiving video/audio content from a content source, a communicator 130 for communicating with the content source, a controller (or control part) 140 for processing the video/audio content received by the content receiver 120 and/or the communicator 130, a display 150 for displaying an image processed by the controller 140, and an audio module (or audio part) 160 for outputting sound processed by the controller 140.

The user input module 110 may include an input button 111 for receiving a user input. For example, the user input module 110 may include a power button for turning on or off the display device 100, a channel selection button for select a broadcast content to be displayed on the display device 100, a sound control button for controlling audio volume output by the display device 100, a source selection button for selecting a content source, etc.

The input button 111 may receive a user input and output an electric signal corresponding to the user input to the controller 140, and may be implemented by various input means such as a push switch, a touch switch, a dial, a slide switch, a toggle switch, etc.

The user input module 110 may also include a signal receiver 112 for receiving a remote control signal from a remote controller 112a. The remote controller 112a for receiving a user input may be provided separately from the display device 100, may receive a user input and transmit a radio signal corresponding to the user input to the display device 100. The signal receiver 112 may receive a radio signal corresponding to a user input from the remote controller 112a, and output an electric signal corresponding to the user input to the controller 140.

The content receiver 120 may include a receiving terminal 121 to receive video/audio content including image data and audio data from a content source, and a tuner 122 to receive a broadcast signal including TV broadcast content and tune to the received broadcast signal.

The receiving terminal 121 may be connected to the content source through a cable to receive video/audio content including image data and audio data from the content source. The video/audio content may be received in a data stream format, and the data stream of the video/audio content (hereinafter, referred to as content data) may be generated by encoding the image data and the audio data.

The receiving terminal 121 may include a component (YPbPr/RGB) terminal and a composite video blanking and sync (CVBS) terminal to receive analog image frame data. The receiving terminal 121 may include a high definition multimedia interface (HDMI) terminal to receive digital image frame data. The receiving terminal 121 may also include a universal serial bus (USB) terminal to receive image data from an external storage medium (e.g., a USB drive).

The tuner 122 may receive broadcast signals through a broadcast receiving antenna or a cable, and extract a broadcast signal on a channel selected by the user from among the broadcast signals. For example, the tuner 122 may pass a TV broadcast signal having a frequency corresponding to a channel selected by the user among multiple TV broadcast signals of various frequencies received through the broadcast receiving antenna 2, and block TV broadcast signals having the other frequencies. The TV broadcast signal may be generated by modulating the data stream of the content, and the display device 100 may generate content data by demodulating the TV broadcast signal.

As such, the content receiver 120 may receive video/audio content from the content source, and output the video/audio content to the controller 140.

The communicator 130 may exchange data with the content source and/or the external device over a communication network. For example, the communicator 130 may receive video/audio content from the content source, or receive information about the video/audio content from the external device. The information about the video/audio content is information about content itself, including a title, type, genre, etc., of the content.

In this case, the communication network may include both wired and wireless communication networks. The wired communication network may include a communication network such as a cable network or a telephone network, and the wireless communication network may include a communication network for transmitting and receiving signals on radio waves. The wireless communication network may also include an access point (AP), and the AP may be connected to the image processing apparatus 100**-->display device** and connected to the wired communication network via cable.

The communicator 130 may include a wired communication module 131 for exchanging data with the content source and/or the external device on wire, and a wireless communication module 132 for exchanging data with the content source and/or the external device wirelessly.

The wired communication module 131 may access a wired communication network and communicate with the content source over the wired communication network. For example, the wired communication module 131 may access the wired communication network through Ethernet (IEEE 802.3 technology standard), and receive data from the content source and/or the external devices over the wired communication network.

The wireless communication module 132 may communicate wirelessly with a base station or an access point (AP), and access the wired communication network via the base station or the AP. The wireless communication module 132 may communicate with the content source and/or the external devices connected to the wired communication network via a base station or the AP. For example, the wireless communication module 132 may use wireless fidelity (Wi-Fi) (the IEEE 802.11 technology standard), to communicate with an AP, or use code divisional multiple access (CDMA), wideband code division multiple access (WCDMA), Global Systems for Mobile communications (GSM), Long Term Evolution (LTE), WiBro, etc., to communicate with a base station. The wireless communication module 132 may receive data from the content source and/or the external device via the base station or the AP.

In addition, the wireless communication module 132 may communicate directly with the content source and/or the external device. For example, the wireless communication module 132 may use Wi-Fi, Bluetooth (IEEE 802.15.1 technology standard), ZigBee (IEEE 802.15.4 technology standard), etc., to wirelessly receive data from the content source and/or the external device.

The communicator 130 may receive video/audio content and/or information about the video/audio content from the content source and/or the external device through the wired communication module 131 and/or the wireless communication module 132, and output the received video/audio content and/or information about the video/audio content to the controller 140 through the wired communication module 131 and/or the wireless communication module 132.

The controller 140 may control the content receiver 120, the communicator 130, the display 150 and/or the audio module 160 according to a user input received through the user input module 110. For example, on receiving a user input to select a content source, the controller 140 may control the content receiver 120 and/or the communicator 130 to receive content data from the selected content source. Furthermore, on receiving a user input for image adjustment and/or sound adjustment, the controller 140 may control the display 150 and/or the audio module 160 to adjust the image and/or sound.

The controller 140 may process image data and/or audio data received by the content receiver 120 and/or the communicator 130. For example, the controller 140 may reconstruct image data by decoding the content data, and output the reconstructed image data through the display 150. Moreover, the controller 140 may reconstruct the audio data by decoding the content data, and generate an analog audio data (hereinafter, audio signal) by processing audio data.

The controller 140 may process the audio signal to provide a constant volume. For example, a constant volume of the sound may be provided by reducing a relatively large volume in the audio signal and increasing a relatively small volume.

The controller 140 may also separate the audio signal into a voice signal and other non-voice signals, and adjust output power of the voice signal and the non-voice signal separately.

The controller 140 may include a microprocessor 141 and a memory 142.

The memory 142 may store programs and/or data for controlling components of the display device 100, and temporarily store control data produced while the components of the display device 100 is being controlled.

The memory 142 may also store programs and data for decoding the content data received by the content receiver 120 and/or the communicator 130, and temporarily store image data and/or audio data produced while the content data is being decoded.

The memory 142 may include a non-volatile memory, such as a Read Only Memory (ROM), a flash memory, and/or the like, which may store data for a long period, and a volatile memory, such as a static random access memory (SRAM), a dynamic RAM (DRAM), or the like, which may temporarily store data.

The microprocessor 141 may receive content data from the content receiver 120 and/or the communicator 130. The microprocessor 141 may decode content data based on the program and data stored in the memory 142, and reconstruct the image data and audio data.

The microprocessor 141 may also be trained to process audio data based on user inputs and environmental information such as content genres, audio properties, audio mode, audio volume, external noise, viewing time (or duration time), etc., and generate an analog audio signal by processing the audio data according to the training result.

The microprocessor 231 may include an operation circuit for performing a logic operation and an arithmetic operation, and a memory circuit for storing the data resulting from the operation.

The display 150 includes a display panel 152 for visually reproducing images, and a display driver 151 for driving the display panel 152.

The display panel 152 may include pixels, each pixel being a unit for displaying images. Each pixel may receive an electric signal representing an image from the display driver 151, and output an optical signal corresponding to the received electric signal. As such, optical signals output from the plurality of pixels P may be combined into one image to be displayed on the display panel 152.

For example, a plurality of pixels may be arranged on the display panel 152, and an image displayed on the display panel 152 may be formed by a combination of rays emitted from the plurality of pixels. For example, the rays emitted by the plurality of pixels may be combined like mosaics into an image on the display panel 152. As described above, each of the plurality of pixels may emit various brightness and colors of light, and each of the plurality of pixels may include a red subpixel, a green subpixel and a blue subpixel to emit various colors of light.

The display panel 152 may be implemented by various types of panels such as a liquid crystal display panel (LCD panel), a light emitting diode panel (LED panel), an organic light emitting diode panel (OLED panel), etc.

The display driver 151 may receive image data from the controller 140, and drive the display panel 152 to display an image corresponding to the received image data. Specifically, the display driver 151 may send an electric signal corresponding to the image data to each of the plurality of pixels of the display panel 152.

When the display driver 151 sends an electric signal corresponding to the image data to each pixel of the display panel 152, the pixel may output a ray corresponding to the electric signal and rays output by the respective pixels may be combined into an image.

The audio module 160 includes an audio amp 161 for amplifying sound, a speaker 162 for audibly outputting the amplified sound and a microphone 163 for collecting surrounding sound.

The controller 140 may process audio data to be converted to an audio signal, and the audio amp 161 may amplify the audio signal output from the controller 140.

The speaker 162 may convert the audio signal amplified by the audio amp 161 to a sound (sound waves). For example, the speaker 162 may include a thin film that vibrates according to an electric audio signal, and the vibration of the thin film may produce sound waves.

The microphone 163 may collect sounds around the display device 100, and convert the collected sound into an electric audio signal. The audio signal collected by the microphone 163 may be output to the controller 140.

As described above, the display device 100 may receive contents including video and audio signals from various content sources and output the video and audio signals included in the content.

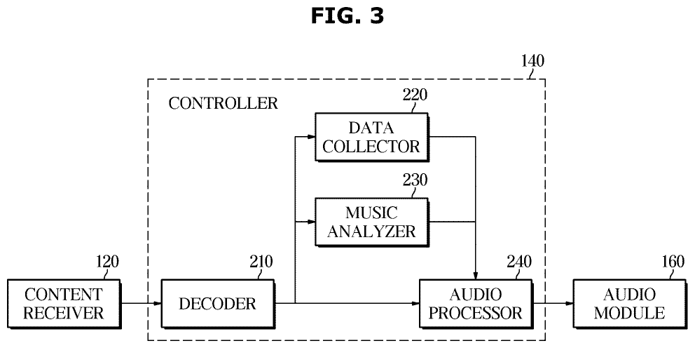

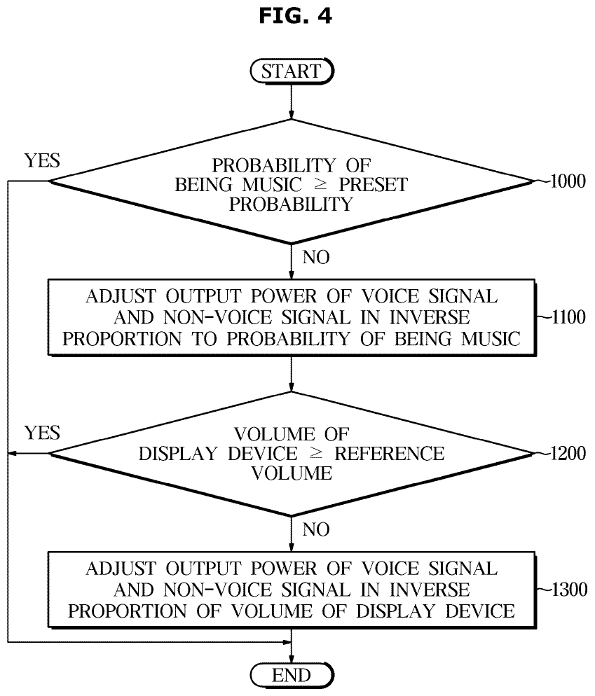

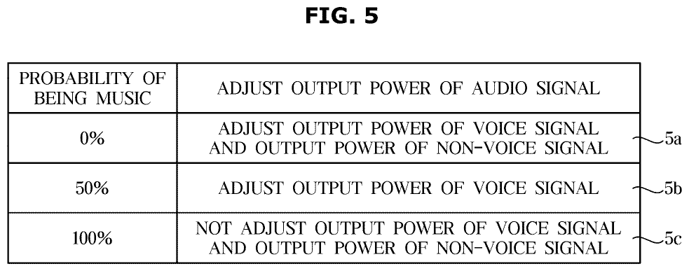

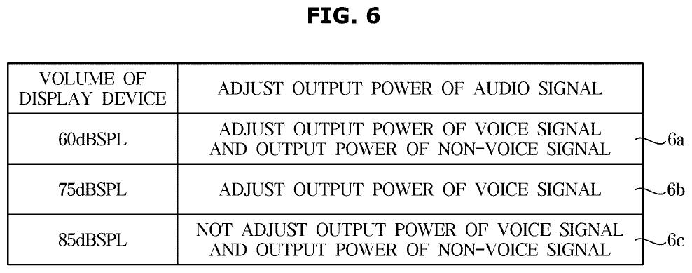

FIG. 3 is a block diagram of a controller included in a display device, according to an embodiment. FIG. 4 is a flowchart for describing a sound output method of a display device, according to an embodiment. FIG. 5 is a diagram for describing adjustment of output power of an audio signal based on a probability that the audio signal is music, according to an embodiment. FIG. 6 is a diagram for describing adjustment of output power of an audio signal based on a volume of a display device, according to an embodiment.

In FIG. 3, the controller 140 includes a decoder 210, a data collector 220, a music analyzer 230 and an audio processor 240. The decoder 210, the data collector 220, the music analyzer 230 and the sound processor 240 may be implemented by an application (software) stored in the memory 142 and running by the microprocessor 141, and/or implemented by a digital circuit (hardware) mounted in the microprocessor 141.

In some embodiments, any one of the decoder 210, the data collector 220, the music analyzer 230 and the sound processor 240 may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters. In some embodiments, any one of the decoder 210, the data collector 220, the music analyzer 230 and the sound processor 240 may be implemented by combinations of the above software components (for example, stored in the memory 142) and hardware components (such as the microprocessor 141).

The decoder 210 may reconstruct image data and audio data by decoding the content data. The content data may be compressed and/or encoded according to various compression and/or encoding standards. For example, the image data of the content data may be compressed and/or encoded using an image compression standard such as H.264/Moving Picture Experts Group-4 Advanced Video Coding (MPEG-4 AVC), H.265/High Efficiency Video Coding (HEVC), etc. The audio data may be compressed and/or encoded using an audio compression standard such as Advanced Audio Coding (AAC), MPEG-H 3D Audio, etc.

The decoder 210 may reconstruct image data from the content data by using an image compression standard, and reconstruct audio data from the content data by using an audio compression standard.

The decoder 210 may output the audio data to the data collector 220, the music analyzer 230 and the audio processor 240.

The data collector 220 may collect information for enhancing voice delivery (hereinafter, referred to as “audio information”). For example, the data collector 220 may collect audio properties, audio mode, audio volume, external noise, current time and time duration of the content.

The data collector 220 may determine audio properties of the content. The audio properties of the content may vary depending on genres of the content, and the genres of the content may include news, dramas, entertainments, sports, documentaries, films, comedies, music, etc.

The data collector 220 may determine the genre of the content by analyzing metadata related to the content. The metadata is information about attributes of the content, including various information that describes the content such as the location and description of the content, information about a creator, information about the genre, etc. Hence, on receiving the meta data of content data along with the content data, the data collector 220 may determine a genre of the content by analyzing the metadata. Furthermore, the data collector 220 may determine audio properties of the content based on the genre of the content.

The data collector 220 may determine a genre of the content and/or a genre of the sound by analyzing the audio data itself in the content. For example, the data collector 220 may determine a genre of the content and/or a genre of the sound by using a genre recognition model. The genre recognition model may be generated in advance through machine learning based on plenty of data for training. The data collector 220 may also determine a genre of the content and/or a genre of the sound based on audio data of a portion of the content.

The data collector 220 may determine a currently set audio mode. The audio mode may indicate an operation mode of the display device 100 regarding audio processing, and depending on the audio mode, the sound amplification factor for each frequency band and the sound amplification factor of voice sound and background sound may be different.

The data collector 220 may determine an audio volume based on the user input through the user input module 110. For example, based on a user input through the input button 111, or a volume up button or a volume down button equipped in the remote controller 112a, the audio volume may be determined.

The data collector 220 may determine external noise around the display device 100 based on an audio signal collected through the microphone 163. For example, the data collector 220 may determine a level of the external noise based on the magnitude of the audio signal collected through the microphone 163.

The data collector 220 may determine current time and time duration of the user based on an output of a timer included in the controller 140. The controller 140 may receive information about the current time from an external device through the communicator 130, or use the timer to compute the current time based on a time setting of the user.

The music analyzer 230 may receive audio data from the decoder 210.

The music analyzer 230 may determine whether the audio signal is music based on the audio data.

Specifically, the music analyzer 230 may determine a probability that the audio signal is music, and based on the probability of being music, determine whether the audio signal is music.

The music analyzer 230 may determine a probability of being music based on a frequency change rate of the audio signal. However, the determining of the probability of being music is not limited thereto, and there are no limitations on methods for determining the probability of being music. For example, the music analyzer 230 may determine the probability of being music by using spectrum analysis and artificial intelligence (AI).

The music analyzer 230 may determine whether the audio signal is music by comparing a probability set in the memory in advance with the probability of being music. Specifically, the music analyzer 230 may determine that the audio signal is music when the probability of being music is equal to or higher than the preset probability. For example, when the preset probability is 80% and the probability of being music is 90%, the current audio signal may be determined as music.

The music analyzer 230 may send the probability of being music and whether it is music to the audio processor 240.

The audio processor 240 may receive audio data from the decoder 210, receive audio information from the data collector 220, and receive information about the probability of being music and whether it is music from the music analyzer 230.

The audio processor 240 may generate an audio signal by processing the audio data based on the received information. The audio processor 240 may output the audio signal to the audio module 160.

Specifically, the audio processor 240 may separate the audio data into voice data and non-voice data, and adjust output power of the voice signal and the non-voice signal.

Voice refers to a human voice or sound of speech and non-voice refers to other sounds than the human voice or sound of speech. For example, the non-voice may be an animal's sound or a background sound.

The audio processor 240 may use statistical data information to separate the voice data and non-voice data from audio data. For example, when an audio input is 5.1 channel, voice is in the center channel, so a sound input on the center channel is determined as voice to separate the sound into voice data and non-voice data, and when an audio input is of a stereo type, the voice data and the non-voice data may be separated by using the fact that voice exists at a sound image angle of 0 degree.

However, the separating of the voice data from the non-voice data is not limited thereto, and there are no limitations on methods for separating the voice data from the non-voice data. For example, the audio processor 240 may use a deep-learning based algorithm to separate the voice data and the non-voice data.

The audio processor 240 may enhance output power of the voice signal to increase voice delivery. In an embodiment, the audio processor 240 may increase output power of the voice signal to increase voice delivery

Specifically, the audio processor 240 may enhance output power of the voice signal by adjusting the volume of the voice signal to be high. Furthermore, the audio processor 240 may enhance the output power of the voice signal by increasing the gain value by a dynamic range compressor.

The audio processor 240 may also adjust the output power of the non-voice signal to increase voice delivery.

Specifically, the audio processor 240 may increase three-dimensional (3D) effect of the non-voice signal by adjusting the output power of the non-voice signal. For example, the audio processor 240 may increase 3D effect of the non-voice signal by performing spatial audio processing on the non-voice signal.

The audio processor 240 may correct the tone balance of the voice data and the non-voice data based on the fact that the user's ability to hear high-frequency audio signals is reduced when the listening volume dBSPL is low. Here, dBSPL is ‘decibels Sound Pressure Level’, a unit used to measure the intensity of sound. As known in the art, a higher dBSPL indicates a louder sound.

The audio processor 240 may also adjust the output power of the voice data and non-voice data according to audio information and a probability of being music. This will now be described with reference to FIGS. 4 to 6.

The data collector 220 may collect information for enhancing voice delivery (hereinafter, referred to as audio information). For example, the data collector 220 may collect audio properties, audio mode, audio volume, external noise, current time and time duration of the content.

Specifically, the data collector 220 may determine an audio volume based on the user input through the user input module 110. For example, based on a user input through the input button 111, or a volume up button or a volume down button equipped in the remote controller 112a, the audio volume may be determined.

The music analyzer 230 may receive audio data from the decoder 210, and based on the received audio data, determine a probability that the audio signal is music and whether the audio signal is music.

The music analyzer 230 may determine a probability that the audio signal is music. For example, the music analyzer 230 may determine a probability of being music based on a frequency change rate of the audio signal.

Furthermore, the music analyzer 230 may compare the probability of being music with a preset probability, in operation 1000.

The music analyzer 230 may determine that the audio signal is music when the probability of being music is equal to or higher than the preset probability in operation 1000. For example, when the preset probability is 80% and the probability of being music is 90%, the current audio signal may be determined as music.

The audio processor 240 may also adjust the output power of the voice data and non-voice data according to the probability that the audio signal is music and whether the audio signal is music.

When the audio signal is music, the audio processor 240 may not adjust the output power of the voice signal and non-voice signal.

Specifically, referring to FIG. 5, when the probability of being music is 0%, the audio processor 240 may enhance the output power of the audio signal as the voice delivery needs to be enhanced, and increase 3D effect of the non-voice signal (“5a” in FIG. 5), when the probability of being music is 50%, the audio processor 240 may enhance only the output power of the voice signal because enhancement of the voice delivery may or may not be required, and may not adjust the non-voice signal (“5b” in FIG. 5), and when the probability of being music is 100%, the audio processor 240 may not adjust the output power of the voice signal and non-voice signal as there is no need to enhance the voice delivery (“5c” in FIG. 5).

Furthermore, when the audio signal is not music in operation 1000, the audio processor 240 may adjust the output power of the voice signal and non-voice signal in inverse proportion to the probability of being music in operation 1100.

For example, the audio processor 240 may increase the audio signal by 10 when the probability that the audio signal is music is 0%, and increase the audio signal by 5 when the probability that the audio signal is music is 50%.

Furthermore, the audio processor 240 may increase the 3D effect by 40% when the probability that the audio signal is music is 30%, and increase the 3D effect by 20% when the probability that the audio signal is music is 60%.

The audio processor 240 may adjust the output power of the voice signal and non-voice signal based on the audio information. Specifically, the audio processor 240 may adjust the output power of the voice signal and the non-voice signal based on the volume of the display device.

The audio processor 240 may compare the volume of the display device with a reference volume stored in the memory in operation 1200. The reference volume refers to a volume that is similar to a content creating environment, e.g., 80 dBSPL.

When the volume of the display device is equal to or higher than the reference volume in operation 1200, the audio processor 240 may not adjust the output power of the voice signal and the non-voice signal.

Specifically, referring to FIG. 6, when the volume of the display device is 60 dBSPL, it requires enhancement of voice delivery because the volume of the display device is lower than the reference volume 80 dBSPL, the audio processor 240 may enhance the output power of the voice signal and increase 3D effect of the non-voice signal (“6a” in FIG. 6), when the volume of the display device is 75 dBSPL, the audio processor 240 may enhance only the output power of the voice signal and may not adjust the non-voice signal because enhancement of the voice delivery may or may not be required (“6b” in FIG. 6), and when the volume of the display device is 85 dBSPL, the audio processor 240 may not adjust the output power of the voice signal and the non-voice signal because the volume of the display device is equal to or higher than the reference volume 80 dBSPL (“6c” in FIG. 6).

Furthermore, when the volume of the display device is lower than the reference volume in operation 1200, the audio processor 240 may adjust output power of the voice signal and non-voice signal in inverse proportion to the volume of the display device in operation 1300.

For example, the audio processor 240 may increase the audio signal by 20 dBSPL when the volume of the display device is 60 dBSPL, and increase the audio signal by 5 dBSPL when the volume of the display device is 75 dBSPL.

Furthermore, the audio processor 240 may increase the 3D effect by 50% when the volume of the display device is 55 dBSPL, and increase the 3D effect by 25% when the volume of the display device is 70 dBSPL.

Moreover, the audio processor 240 may adjust the output power of the voice signal and the non-voice signal based on the probability of being music and the volume of the display device. For example, when the probability of being music is 0% but the volume of the display device is 85 dBSPL, which is high enough so that there is no need to enhance the voice delivery, the output power of the voice signal and the non-voice signal may not be adjusted, and when the probability of being music is 50% and the volume of the display device is 60 dBSPL, which requires enhancement of the voice delivery, the output power of the voice signal may be enhanced and the 3D effect of the non-voice signal may be increased.

Furthermore, according to an embodiment, the audio processor 240 may adjust the output power of the voice signal and non-voice signal based on the genre of the content. For example, when the genre of the content is dramas, the output power of the voice signal and the non-voice signal may be enhanced, and the genre of the content is sports for which voice delivery is less important than for dramas, only the output power of the non-voice signal may be enhanced.

The audio processor 240 may output the adjusted audio signal to the audio module 160. The audio module 160 may output a sound according to the adjusted audio signal.

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. A display device comprising:
a content receiver configured to receive content data from a content source; and
a processor operatively connected to the content receiver,
wherein the processor is configured to:
obtain audio data from the content data and convert the audio data to an audio signal,
adjust at least one of first output power of a voice signal included in the audio signal or second output power of a non-voice signal included in the audio signal, based on whether the audio signal is music or a volume.

2. The display device of claim 1, wherein the processor is further configured to determine a probability that the audio signal is music, and enhance first output power of the voice signal in inverse proportion to the probability.

3. The display device of claim 2, wherein the processor is further configured to enhance a three-dimensional (3D) effect of the non-voice signal in inverse proportion to the probability.

4. The display device of claim 2, wherein the processor is further configured to determine the audio signal as music, based on the probability being equal to or higher than a preset probability, and
wherein the processor is further configured not to enhance the first output power of the voice signal, based on the audio signal being music.

5. The display device of claim 1, wherein the processor is further configured to enhance the first output power of the voice signal in inverse proportion to the volume.

6. The display device of claim 1, wherein the processor is further configured to enhance a three-dimensional (3D) effect of the non-voice signal in inverse proportion to the volume.

7. The display device of claim 1, wherein the processor is further configured not to enhance the first output power of the voice signal, based on the volume being equal to or higher than a preset reference volume.

8. A sound output method comprising:
receiving content data from a content source;
obtaining audio data from the content data;
converting the audio data to an audio signal; and
adjusting at least one of first output power of a voice signal included in the audio signal or second output power of a non-voice signal included in the audio signal, based on whether the audio signal is music or a volume.

9. The sound output method of claim 8, wherein the adjusting of the first output power of the voice signal comprises determining a probability that the audio signal is music, and enhancing the first output power of the voice signal in inverse proportion to the probability.

10. The sound output method of claim 9, wherein the adjusting of the second output power of the non-voice signal comprises enhancing a three-dimensional (3D) effect of the non-voice signal in inverse proportion to the probability.

11. The sound output method of claim 9, wherein the adjusting of the first output power of the voice signal comprises:
determining the audio signal as music, based on the probability being equal to or higher than a preset probability, and
not enhancing the first output power of the voice signal, based on the audio signal being music.

12. The sound output method of claim 8, wherein the adjusting of the first output power of the voice signal comprises enhancing the first output power of the voice signal in inverse proportion to the volume.

13. The sound output method of claim 8, wherein the adjusting of the second output power of the non-voice signal comprises enhancing a three-dimensional (3D) effect of the non-voice signal in inverse proportion to the volume.

14. The sound output method of claim 8, wherein the adjusting of the first output power of the voice signal comprises not enhancing the first output power of the voice signal, based on the volume being equal to or higher than a preset reference volume.
